(19) United States
(12) Patent Application Publication
(10) Pub. No.: US 2026/0065818 A1
(43) Pub. Date: Mar. 5, 2026

(54) AUXILIARY DISPLAY METHOD FOR MEDICAL IMAGE AND MEDICAL IMAGE PROCESSING APPARATUS

(71) Applicant: GE Precision Healthcare LLC, Waukesha, WI (US)

(72) Inventors: Yuqing Ma, Shanghai (CN); Xiaoqing Shangguan, Shanghai (CN)

(21) Appl. No.: 19/313,716

(22) Filed: Aug. 28, 2025

(30) Foreign Application Priority Data
Aug. 29, 2024 (CN) 202411200088.1

(51) Int. Cl. G09G 3/00; G06T 7/00

(52) U.S. Cl. CPC G09G 3/001; G06T 7/0012; G06T 2207/20084; G09G 2300/023; G09G 2340/0464; G09G 2380/08

(57) ABSTRACT

A method for auxiliary display of a medical image, comprising: acquiring a medical image from a medical imaging device in real time, the medical imaging device comprising a display for displaying the medical image in real time; performing real-time processing on the medical image to generate a processing result; and displaying the processing result on a transparent display device, and matching the position of the processing result with the position of the medical image in a direction perpendicular to the transparent display device. Further provided in the present application are a medical image processing apparatus and a medical system.

### CROSS-REFERENCE TO RELATED APPLICATION

This application claim priority to Chinese Patent Application No. 202411200088.1, which was file on Aug. 29, 2024 at the Chinese Patent Office. The entire contents of the above-listed application are incorporated by reference herein in their entirety.

### TECHNICAL FIELD

The present invention relates to the field of medical imaging, in particular to a method and apparatus for auxiliary display during the processing of a medical image.

### BACKGROUND ART

Medical imaging devices are widely used in the medical field. Typical medical imaging devices may include ultrasound imaging devices, endoscopes, etc. These devices are capable of performing real-time imaging on a patient, particularly inside of the patient's body, so as to assist a physician in diagnosis or treatment.

With the advancement of technology, more and more automated image processing tools are used to assist in diagnosis. These tools can acquire image data of a medical imaging device, and process images using algorithms stored therein so as to assist in diagnosis. Many image processing tools are used by users as standalone products. The reason may be that these processing tools have a higher degree of flexibility, are updated faster than medical imaging devices, and are suitable for being developed independently rather than being directly integrated into the medical imaging devices.

### SUMMARY OF THE INVENTION

The inventors found that a standalone image processing tool might cause a certain degree of inconvenience to users. Specifically, the image processing tool requires a built-in display device to display a processing result. When a user performs real-time imaging, the user needs to repeatedly shift his/her gaze between the display of the image processing tool and a display of an imaging device, which affects the operation efficiency and the use experience. In addition, if the processing result is intended to be transmitted to the medical imaging device for displaying, it is necessary to update the medical imaging device promptly to ensure that it adapts to the latest image processing tool. This is difficult to achieve for a relatively closed imaging device system, and could incur additional costs and risks. The aforementioned defects, deficiencies, and problems are solved herein, and these problems and solutions will be understood through reading and understanding the following description.

Provided in some embodiments of the present application is a method for auxiliary display of a medical image, comprising: acquiring a medical image from a medical imaging device in real time, the medical imaging device comprising a display for displaying the medical image in real time; performing real-time processing on the medical image to generate a processing result; and, displaying the processing result on a transparent display device, and matching the position of the processing result with the position of the medical image in a direction perpendicular to the transparent display device.

Optionally, the real-time processing comprises at least one of image recognition, image segmentation, and image measurement. correspondingly, the processing result comprises at least one of a recognition result of a region of interest, a recognition result of a lesion, a classification of a lesion, a bounding box of a region of interest, a bounding box of a lesion, a coloration, and a measurement result.

Optionally, the real-time processing comprises processing using deep neural networks.

Optionally, the transparent display device is controlled not to display the medical image while the processing result is being displayed on the transparent display device.

Optionally, the matching the position of the processing result with the position of the medical image in a direction perpendicular to the transparent display device comprises: receiving information with respect to the resolution and size of the display, and determining the positions of pixel points on the display that are used for displaying the medical image; comparing the information with respect to the resolution and size of the display with information with respect to the resolution and size of the transparent display device; and, on the basis of the comparison result, adjusting the positions of pixel points on the transparent display device that are used for displaying the processing result such that the pixel points correspond, in the direction perpendicular to the transparent display device, to the pixel points that are used for displaying the medical image.

Some embodiments of the present application further provide a medical image processing apparatus, comprising: a processor; and a non-transitory memory, wherein the non-transitory memory has instructions stored therein, and the instructions, when executed, cause the processor to perform the method described in any of the foregoing embodiments.

Optionally, the apparatus further comprises: a transparent display device, the transparent display device allowing a display located therebehind to be observed through the transparent display device.

Optionally, the apparatus further comprises: a fixing apparatus, the fixing apparatus being connected to the transparent display device and being capable of fixedly connecting the display to the transparent display device.

Optionally, the fixing apparatus is further configured to be allowed to perform positional adjustment on the transparent display device in at least one of a horizontal direction and a vertical direction.

Optionally, the apparatus further comprises: a data receiving module, the data receiving module being used to receive a medical image from the medical imaging device in real time for the processor to perform real-time processing.

Optionally, the data receiving module further receives information with respect to the resolution and size of the display of the medical imaging device.

Some embodiments of the present application further provide a medical system, comprising the medical image processing apparatus as described in any of the foregoing embodiments.

Optionally, the medical system further comprises a medical imaging device, the medical imaging device comprising at least one of an ultrasound imaging device, an endoscope, an X-ray imaging device, and a magnetic resonance imaging device.

It should be understood that the brief description above is provided to introduce, in a simplified form, concepts that will be further described in the detailed description. The brief description above is not meant to identify key or essential features of the claimed subject matter. The scope is defined uniquely by the claims that follow the detailed description. Furthermore, the claimed subject matter is not limited to implementations that solve any deficiencies raised above or in any section of the present disclosure.

### BRIEF DESCRIPTION OF THE DRAWINGS

The present application will be better understood by reading the following description of non-limiting embodiments with reference to the accompanying drawings, where:

FIG. 1 is a schematic block diagram of an embodiment of a medical system of the present application;

FIG. 2 shows a method for auxiliary display of a medical image in some embodiments of the present application;

FIG. 3 shows a method for performing adaption between display apparatuses in some embodiments of the present application;

FIG. 4 shows a schematic diagram of performing auxiliary display using a transparent display device in some embodiments of the present application; and

FIG. 5 shows a schematic diagram of a medical system comprising a medical image processing apparatus.

### DETAILED DESCRIPTION

Specific implementations of the present invention will be described below. It should be noted that in the specific description of the implementations, it is impossible to describe all features of the actual implementations of the present invention in detail, for the sake of brief description. It should be understood that in the actual implementation process of any implementation, just as in the process of any one engineering project or design project, a variety of specific decisions are often made to achieve specific goals of the developer and to meet system-related or business-related constraints, which may also vary from one implementation to another. Furthermore, it should also be understood that although efforts made in such development processes may be complex and tedious, for those of ordinary skill in the art related to the content disclosed in the present invention, some design, manufacture, or production changes made on the basis of the technical content disclosed in the present disclosure are only common technical means, and should not be construed as the content of the present disclosure being insufficient.

Unless otherwise defined, the technical or scientific terms used in the claims and the description should be as they are usually understood by those possessing ordinary skill in the technical field to which they belong. “First”, “second”, and similar words used in the present invention and the claims do not denote any order, quantity, or importance, but are merely intended to distinguish between different constituents. The terms “one” or “a/an” and similar terms do not express a limitation of quantity, but rather that at least one is present. The terms “include” or “comprise” and similar words indicate that an element or object preceding the terms “include” or “comprise” encompasses elements or objects and equivalent elements thereof listed after the terms “include” or “comprise”, and do not exclude other elements or objects. The terms “connect” or “link” and similar words are not limited to physical or mechanical connections, and are not limited to direct or indirect connections.

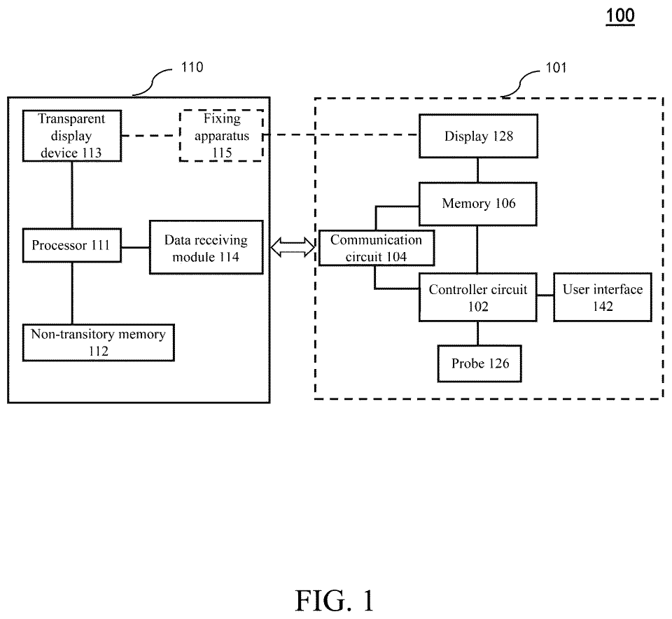

FIG. 1 shows a schematic block diagram of an embodiment of a medical system 100. The medical system 100 may comprise a medical image processing apparatus 110 and a medical imaging device. In the exemplary description hereinunder, the medical imaging device is described by taking an ultrasound imaging device 101 as an example. However, it may be understood that in other examples, the medical imaging device may be other devices, such as at least one of an endoscope, an X-ray imaging device (comprising a computed tomography device), and a magnetic resonance imaging device.

Reference is first made to the medical image processing apparatus 110 in FIG. 1. It may comprise a processor 111, a non-transitory memory 112, a transparent display device 113, and a data receiving module 114.

The processor 111 may process medical image data from an external device, such as the ultrasound imaging device 101. The medical image data may be acquired from the ultrasound imaging device through the data receiving module 114. For example, the data receiving module 114 may comprise a transceiver, a receiver, etc., and an associated circuit system (e.g., an antenna) for communicating (e.g., transmitting and/or receiving) in a wired and/or wireless manner with one or more alternative external systems, remote servers, etc. Protocol firmware for transmitting and/or receiving data along a bidirectional communication link may be stored in the non-transitory memory 112 accessed by the processor 111. The protocol firmware provides network protocol syntax to the processor 111 so as to assemble a data packet, establish and/or segment data received along the bidirectional communication link, and so on. The bidirectional communication link may be a wired (e.g., by means of a physical conductor) and/or wireless communication (e.g., utilizing a radio frequency (RF)) link for exchanging data (e.g., a data packet) between the ultrasound imaging device 101 and the medical image processing apparatus 110. The bidirectional communication link may be based on a standard communication protocol, such as Ethernet, TCP/IP, Wi-Fi, 802.11, a customized communication protocol, Bluetooth, etc. In addition, the data receiving module 114 may also be used to receive other information than the image information. For example, it may be used to further receive information with respect to the resolution, size, etc. of a display of the medical imaging device. An exemplary description of the specific functions of these items of information will be given hereinunder.

The non-transitory memory 112 may store the received medical image data, and may also store a parameter, an algorithm, etc., used by the processor 111 to perform one or more operations described in the present application. The non-transitory memory 112 may be a tangible and non-transient computer-readable medium, such as a flash memory, a RAM, a ROM, an EEPROM, etc. The non-transitory memory 112 may comprise one or more learning algorithms (e.g., deep learning algorithms including a convolutional neural network algorithm, machine learning algorithms such as a decision tree learning algorithm, conventional computer vision algorithms, etc.) configured to define an image analysis algorithm. In an example, the foregoing algorithms may comprise one or a plurality of neural networks, such as one or a plurality of deep neural networks. In embodiments comprising a plurality of deep neural networks, each of the deep neural networks may be configured to implement a different function. For example, each of the deep neural networks may be separately directed to a different type of medical image, such as a medical image of a different site. With regard to the deep neural network arrangement manner, reference can be made to any manner in the prior art. For example, a deep neural network may be divided into two or more than two layers, such as an input layer for receiving an input image, an output layer for outputting a processing result, and/or one or more intermediate layers. Layers of a neural network represent different groups or sets of artificial neurons, and may represent different functions that are executed by the processor 111 on the input image to identify an object of the input image. The training and output of deep neural networks vary depending on purposes. In an example of image recognition, a deep neural network may be used to determine one or more anatomical features contained in an input image. Artificial neurons in a layer of the deep neural network may examine individual pixels in the input image. The artificial neurons use different weights in a function applied to the input image, so as to attempt to identify an object in the input image. By assigning or associating different pixels in the output image with different anatomical features on the basis of analysis of pixel characteristics, the deep neural network may output a processing result, i.e., a recognition result with respect to the medical image (e.g., region of interest, lesion, benignity or malignancy, etc.).

It can be understood that the foregoing is an exemplary description of deep neural networks. Depending on different expected output results, deep neural networks may also be trained for outputs for other different purposes. In addition, with regard to the training process and means of deep neural networks, reference can be made to any means in the prior art other than as exemplarily described hereinabove in the present application, which will not be limited in the present disclosure.

After the processor 111 processes a medical image, it can control the transparent display device 113 to perform displaying. For implementation of the transparent display device 113, reference can be made to any manner in the prior art. The transparent display device 113 may include, for example, at least one of a transparent LCD display device, a transparent LED display device, and a transparent OLED display device. Besides being capable of displaying a processing result, the transparent display device 113 is also capable of allowing an object (e.g., a display) located therebehind to be observed through the transparent display device 113. Hence, when the medical image processing apparatus 110 and the medical imaging device are used at the same time, the transparent display device 113 and the display of the medical imaging device are arranged in a stacked manner such that the content on the display is not significantly blocked when one observes the content displayed by the transparent display device 113.

An exemplary description of the ultrasound imaging device 101 is given below. In an optional embodiment, the ultrasound imaging system 101 may comprise a controller circuit 102, a display 128, a user interface 142, a probe 126, and a memory 106, which are operatively connected to a communication circuit 104.

The controller circuit 102 is configured to control an operation of the ultrasound imaging device 101. The controller circuit 102 may include one or more processors. Optionally, the controller circuit 102 may include a central processing unit (CPU), one or more microprocessors, a graphics processing unit (GPU), or any other electronic component capable of processing inputted data according to a specific logic instruction. Optionally, the controller circuit 102 may include and/or represent one or more hardware circuits or circuit systems, and the hardware circuit or circuit system includes, is connected to, or includes and is connected to one or more processors, controllers, and/or other hardware logic-based apparatuses. Additionally or alternatively, the controller circuit 102 may execute an instruction stored on a tangible and non-transitory computer-readable medium (e.g., the memory 106).

The controller circuit 102 may be operatively connected to and/or control the communication circuit 104. The communication circuit 104 is configured to receive and/or transmit information along a bidirectional communication link with one or more alternative ultrasound imaging devices or remote servers, or the medical image processing apparatus as described in any embodiment of the present application, etc. The communication circuit 104 may represent hardware for transmitting and/or receiving data along a bidirectional communication link. In an example, the communication circuit 104 is used to establish a link with the data receiving module 114 for transmission of medical data between the ultrasound imaging device 101 and the medical image processing apparatus 110.

The controller circuit 102 is operatively connected to the display 128 and the user interface 142. The display 128 may include one or more liquid crystal display apparatuses (e.g., LEDs), organic light emitting diode (OLED) display apparatuses, plasma display apparatuses, CRT display apparatuses, and the like. The display 128 may display patient information received by the display 128 from the controller circuit 102, one or more medical images and/or videos, a graphical user interface or a component, one or more 2D, 3D or 4D ultrasound image data sets from ultrasound data stored in the memory 106, or anatomical measurement, diagnosis, processing information and the like currently acquired in real time.

The user interface 142 controls operation of the controller circuit 102 and the ultrasound imaging device 101. The user interface 142 is configured to receive an input from a clinician and/or an operator of the ultrasound imaging device 101. The user interface 142 may include a keyboard, a mouse, a trackball, a touch pad, one or more physical buttons, and the like. Optionally, the display 128 may be a touch screen display apparatus that comprises at least a portion of the user interface 142. For example, a portion of the user interface 142 may correspond to a graphical user interface (GUI) that is generated by the controller circuit 102 and displayed on the display 128. The touch screen display apparatus may detect the presence of a touch from the operator on the display 128, and may also identify the position of the touch relative to the surface area of the display 128. For example, a user may select, by touching or contacting the display 128, one or more user interface components of the GUI shown on the display apparatus. The user interface components may correspond to icons, text boxes, menu bars, etc., shown on the display 128. A clinician may select, control, and use a user interface assembly, interact with the same, and so on, so as to send an instruction to the controller circuit 102 to perform one or more operations described in the present application. For example, a touch may be applied using at least one among a hand, a glove, a stylus, and the like.

With continued reference to FIG. 1, the ultrasound imaging device 101 may comprise the probe 126. The probe 126 has elements such as an ultrasound transducer, a transmitter, a transmit beam former, a detector/SAP electronics, etc., (not shown). The detector/SAP electronics may be used to control the switching of the transducer elements. The detector/SAP electronics may also be used to group the transducer elements into one or more sub-holes. Configurations of the probe 126 will also be described below exemplarily. The probe 126 may be any type of probe, including a linear probe, a curved array probe, a 1.25D array probe, a 1.5D array probe, a 1.75D array probe, or a 2D array probe. According to a preferred embodiment of the present application, the probe 126 may be a probe for volumetric imaging. For example, the probe 126 may be an electronic 4D (E4D) probe. In addition, the probe 126 may also be a mechanical probe, for example, a mechanical 4D probe or a hybrid probe. The probe 126 may be configured to acquire 4D ultrasound data, and the 4D ultrasound data includes information about how the volume changes over time, and may be processed to obtain a volumetric ultrasound image related to the site to be imaged. It can be understood that each volume may include a plurality of 2D images or slices, and accordingly, the controller circuit may select a required 2D image from the volumetric ultrasound images. Regarding the generation of a 2D or 4D image, the image may be obtained through processing in which the controller circuit 102 executes one or more algorithms, one or more ultrasonic examination protocols, etc., stored in the memory 106. The memory 106 may be a tangible and non-transitory computer-readable medium such as a flash memory, a RAM, a ROM, an EEPROM, etc.

The probe 126 may include an ultrasound transducer. The probe may be configured to acquire ultrasound data or information from tissue to be imaged (e.g., organs such as breasts and the heart, corresponding skin surfaces outside organs, etc.) of a patient. The probe 126 is communicatively connected to the controller circuit by means of the transmitter. The transmitter transmits a signal to the transmit beam former on the basis of acquisition settings received by the controller circuit 102. The acquisition settings may define the amplitude, pulse width, frequency, gain setting, scanning angle, power, time gain compensation (TGC), resolution, and the like of the ultrasound pulses emitted by the ultrasound transducer. The ultrasound transducer emits a pulsed ultrasound signal into a patient (e.g., the body). The acquisition settings may be defined by a user operating the user interface 142. The signal transmitted by the transmitter, in turn, drives the ultrasound transducer.

The ultrasound transducer transmits the pulsed ultrasound signal to a body (e.g., a patient) or a volume that corresponds to an acquisition setting along one or more scanning planes. The ultrasound signal may include, for example, one or more reference pulses, one or more push pulses (e.g., shear waves), and/or one or more pulsed wave Doppler pulses. At least a portion of the pulsed ultrasound signal is backscattered from a tissue to be imaged (e.g., an organ, bone, heart, breast tissue, liver tissue, cardiac tissue, prostate tissue, newborn brain, embryo, abdomen, etc.) to produce an echo. Depending on the depth or movement, the echo is delayed in time and/or frequency, and received by the ultrasound transducer. The ultrasound signal may be used for imaging, for producing and/or tracking a shear wave, for measuring changes in location or velocity within an anatomical structure and a compressive displacement difference (e.g., strain) of tissue, and/or for treatment and other applications. For example, the probe 126 may deliver low energy pulses during imaging and tracking, deliver medium and high energy pulses to produce shear waves, and deliver high energy pulses during treatment.

The ultrasound transducer converts a received echo signal into an electrical signal that can be received by the receiver. The receiver may include one or more amplifiers, analog/digital converters (ADCs), and the like. The receiver may be configured to amplify the received echo signal after appropriate gain compensation, and convert these analog signals received from each transducer element into a digitized signal that is temporally uniformly sampled. The digitized signals representing the received echoes are temporarily stored in the memory 106. The digitized signals correspond to the backscattered waves received by each transducer element at different times. After being digitized, the signal may still retain the amplitude, frequency, and phase information of the backscattered wave.

Optionally, the controller circuit 102 may retrieve the digitized signals stored in the memory 106 for use in a beam former processor. For example, the controller circuit 102 may convert the digitized signal into a baseband signal or compress the digitized signal.

In some embodiments, the controller circuit 102 may further comprise a beam former processor. The beam forming processor may include one or more processors. If desired, the beam forming processor may include a central processing unit (CPU), one or more microprocessors, or any other electronic component capable of processing the input data according to specific logic instructions. Additionally or alternatively, the beam forming processor may execute instructions stored on a tangible and non-transitory computer-readable medium (e.g., the memory 106) to perform beam forming computation using any suitable beam forming method, such as adaptive beam forming, synthetic emission focusing, aberration correction, synthetic aperture, clutter suppression, and/or adaptive noise control, etc.

In some embodiments, the controller circuit 102 may further include a radio frequency (RF) processor. The beam forming processor executes beam forming on the digitized signals of the transducer elements, and outputs an RF signal. The RF signal is then provided to the RF processor for processing the RF signal. The RF processor may include one or more processors. If desired, the RF processor may include a central processing unit (CPU), one or more microprocessors, or any other electronic component capable of processing the inputted data according to specific logic instructions. Additionally or alternatively, the RF processor may execute instructions stored on a tangible and non-transitory computer-readable medium (e.g., the memory 106). Optionally, the RF processor may be integrated with and/or be part of the controller circuit 102. For example, operations described as being executed by the RF processor may be configured to be executed by the controller circuit 102.

The RF processor may generate, for a plurality of scanning planes or different scanning modes, different ultrasound image data types and/or modes, e.g., B-mode, color Doppler (e.g., color blood flow, velocity/power/variance), tissue Doppler (velocity), and Doppler energy, on the basis of a predetermined setting of a first model. For example, the RF processor may generate tissue Doppler data for multiple scanning planes. The RF processor acquires the information (e.g., I/Q, B-mode, color Doppler, tissue Doppler, and Doppler energy information) related to a plurality of data pieces, and stores the data information in the memory 106, where the data information may include time stamp and orientation/rotation information.

Optionally, the RF processor may include a composite demodulator (not shown) for demodulating the RF signal to generate an IQ data pair representing an echo signal. The RF or IQ signal data may be provided directly to the memory 106 so as to be stored (e.g., stored temporarily). If desired, an output of the beam forming processor may be delivered directly to the controller circuit 102.

The controller circuit 102 may be configured to process the acquired ultrasound data (e.g., RF signal data or IQ data pairs), and prepare and/or generate frames of ultrasound image data representing an anatomical structure of interest so as to display the same on the display 128. The acquired ultrasound data may be processed in real time by the controller circuit 102 during a scanning or treatment process of ultrasound examination when echo signals are received, and may further be displayed in real time on the display 128.

In some embodiments, the transparent display device 113 may be fixedly connected to the display 128. The fixed connection can ensure a fixed relative positional relationship between the two display apparatuses when they perform displaying at the same time, thereby facilitating mutual coordination between the contents displayed. Optionally, the fixed connection may be implemented by means of a fixing apparatus 115. As shown in FIG. 1, the fixing apparatus 115 is connected to the transparent display device 113 and can fixedly connect the display 128 to the transparent display device 113. In one example, the fixing apparatus 115 may be an adhesive or the like, which adheres the two display apparatuses together. In another example, the fixing apparatus 115 may be any type of clamp, for example, a clamp which is disposed at a top portion of the transparent display device 113 and is capable of connection with the display 128. In addition, in some examples, the fixing apparatus 115 is further configured to be allowed to perform positional adjustment on the transparent display device in at least one of a horizontal direction and a vertical direction. The horizontal and vertical directions may be understood as horizontal and vertical directions along a plane where the display apparatus lies, or understood as an X-axis direction and a Y-axis direction. Using the fixing apparatus 115 to perform positional adjustment enables the transparent display device 113 to be adapted to different types of the display 128. For example, while different displays have different sizes, frame sizes, etc., the fixing apparatus 115 enables the same transparent display device 113 to be adapted to different types of the displays 128. Adjusting the position of the transparent display device 113 by adjusting the fixing apparatus 115 can ensure alignment between the two display devices.

As described hereinabove in the present application, in the prior art, a medical image processing apparatus is used as an external device, providing flexibility and a greater multitude of functions for medical imaging devices. The medical image processing apparatus may be separately manufactured by a manufacturer to cater to the needs of diverse users and make up for the deficiencies of medical imaging devices. However, when a user such as a doctor uses a medical image processing apparatus and a medical imaging device at the same time, the user will have to look at their respective displays separately, which will affect the efficiency of operation. At least in view of this, improvements are provided in some embodiments of the present application.

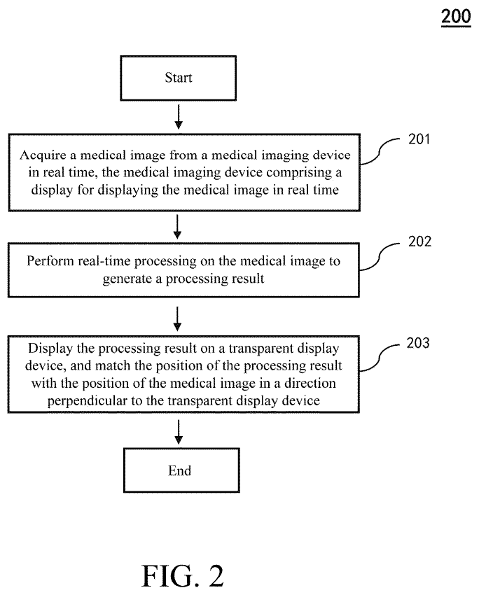

With reference to FIG. 2, there shows a method 200 for auxiliary display of a medical image in some embodiments of the present application, which comprises:
at step 201, acquiring a medical image from a medical imaging device in real time, the medical imaging device comprising a display for displaying the medical image in real time;
at step 202, performing real-time processing on the medical image to generate a processing result; and
at step 203, displaying the processing result on a transparent display device, and matching the position of the processing result with the position of the medical image in a direction perpendicular to the transparent display device.

According to the arrangement in the above embodiment, through communication with the medical imaging device, the medical image collected by the imaging device can be acquired in real time and processed, and the processing result is delivered to the transparent display device to be displayed thereon. On the one hand, it can be ensured that when a user places the transparent display device in front of the display of the medical imaging device in a stacked manner, the transparent display device would not block the user's line of sight to the display. On the other hand, the processing result displayed on the transparent display device and the actual medical image on the display device match each other in terms of positional relationship in the direction perpendicular to the transparent display device (or, it may be understood as the direction of the user's line of sight while observing). The above two aspects together can achieve an effect that when the user looks at the two display devices at the same time, the contents displayed by the two display devices match each other and can be observed in a superimposed manner. In addition, in the above embodiment, there is no need to make additional adaptation or adjustment to the medical imaging device. Explanation is made with reference to FIG. 1. Therefore, in some embodiments, a user needs to look at two display apparatuses in an actual use scenario. For example, the two display apparatuses are the display 128 of the ultrasound imaging apparatus 101 and the transparent display device 113 of the medical image processing apparatus 110, respectively. In a conventional configuration, the display 128 and the transparent display device 113 that are separately disposed will distract the user during use and cause inconvenience in observation. Thanks to the light transmitting characteristics of the transparent display device 113 in the embodiments of the present application, the user may arrange the two display devices in a stacked manner so as to perform displaying.

It can be understood that the types of the real-time processing described above may vary depending on the type of the medical image, the purpose of imaging, etc. In some embodiments, the real-time processing comprises at least one of image recognition, image segmentation, and image measurement. Correspondingly, the processing result comprises at least one of a recognition result of a region of interest, a recognition result of a lesion, a classification of a lesion, a bounding box of a region of interest, a bounding box of a lesion, a coloration, and a measurement parameter. An exemplary description is provided below.

In some examples, the real-time processing may comprise image recognition. A target of recognition may be a region of interest, for example, an imaged object (an organ such as the heart or a blood vessel, or a fetus, etc.) in the image, an anatomical feature (e.g., a key physiological anatomical structure) in the imaged organ, or an interventional object (e.g., a needle) in an interventional operation. The target of recognition may also be a lesion, such as a tumor, a node, etc. In addition, it may also be a combination of the above-identified lesions and regions of interest. Correspondingly, the processing result may comprise a recognition result of the above-identified region of interest or a recognition result of the above-identified lesion, such as the name of the region of interest or lesion. In addition, the processing result may also be a classification of the lesion further made on the basis of the recognition result of the lesion, such as benignity or malignancy, and grade, etc.

In some examples, the real-time processing may also comprise image segmentation. Image segmentation may be performed on the basis of image recognition. For example, image recognition may be performed first to determine a boundary between a region of interest, a lesion, etc. and the surrounding tissue in an image. Then, image segmentation is performed according to the boundary, such that the boundary of the desired portion is cut off from the complete image. Correspondingly, the real-time processing result may include a bounding box of the region of interest or a bounding box of the lesion. The bounding box may be drawn along the boundary between the region of interest or lesion and the surrounding tissue. In other examples, the bounding box may also be of a fixed shape, such as a rectangle or a circle, provided that it is certain that the position of the region of interest or lesion is located within the box. In addition, the real-time processing result may also be a coloration. For example, the position of the region of interest or lesion is applied with a color different from that of the surrounding tissue so as to facilitate observation by the user. In preferred examples, the coloration may correspond to the benignity or malignancy of the tissue in the imaged region. For example, a healthy region of interest is depicted in a first color, e.g., green, an unhealthy region is depicted in a second color, e.g., yellow, a malignant lesion is depicted in a third color, e.g., red, etc.

In other examples, the real-time processing result may include image measurement. An object of image measurement may likewise be a region of interest or a lesion, etc. For example, it may be the size of a region of interest such as a blood vessel, certain organs of a fetus, etc., or alternatively, it may also be brightness information of an ultrasound image, such as the brightness of the liver, etc. Correspondingly, the processing result may include the results of the above measurements, for example, the values of the measurement results such as the size, the brightness, etc.

It can be understood that different scenarios of image recognition, image segmentation and image measurement have been separately described hereinabove. However, in some other embodiments, the real-time processing may be performed at least partially simultaneously. For example, recognition and segmentation are performed simultaneously. Correspondingly, the processing result may include both the result of the recognition and that of the segmentation, for example, information of both the bounding box and the recognition result. As another example, recognition, segmentation and measurement may be performed simultaneously. Correspondingly, the processing result may simultaneously include the bounding box, the information of recognition, and the parameter information obtained from the measurement. One of or combinations of these may be derived from the user's setting, or may be system default.

It can be understood that the real-time processing may be implemented using different algorithms. In some examples, conventional algorithms may be involved. For example, the boundary of an imaged tissue may be determined according to changes in brightness value obtained by calculating and comparing the brightness values of different pixels. In other examples, the real-time processing may include processing using deep neural networks. Reference can be made to the description hereinabove for the training and the way of use of deep neural networks, which will not be repeated here.

In some examples, the transparent display device is controlled not to display the medical image while the processing result is being displayed on the transparent display device. As described above, the position at which the processing result is displayed on the transparent display device is configured to match the position of the medical image on the display of the medical imaging device, and on this basis, there is no need to further display the medical image on the transparent display device. In this way, the displayed contents of the two display devices do not overlap with each other, thereby reducing the requirement for alignment of the two. For example, even if there exists a slight deviation, there would be no adverse effects such as visual ghosting. Since it is not necessary to display the medical image, it can be ensured that the transparent display device has a higher response speed, so that the display result is more real-time and has a better correspondence to the medical image. In addition, such a configuration is beneficial for selecting a better transparent display device. For example, a low-cost transparent display device may be selected. Since such a transparent display device does not need to depict image details, it does not have to have the function of emitting light in various spectral ranges, but may only emit visible light of some frequencies, such as yellow light or red light. That is, the transparent display device in this case may be different from a conventional display screen, and may be understood as a light board having a certain resolution, thereby saving costs. As another example, a transparent display device having a better light transmittance may be selected. Also, since there is no need to take into account the function of displaying image details of the transparent display device, more attention may be paid to the observability of the display disposed behind the transparent display device. For example, part of the function of displaying of the transparent display device may be sacrificed so as to ensure its light transmission capability, which may be a better choice for a user who only needs to look through the transparent display device to observe the processing result. The specific structure and principle of the transparent display device may be implemented with reference to any manner in the prior art, and will not be repeated here.

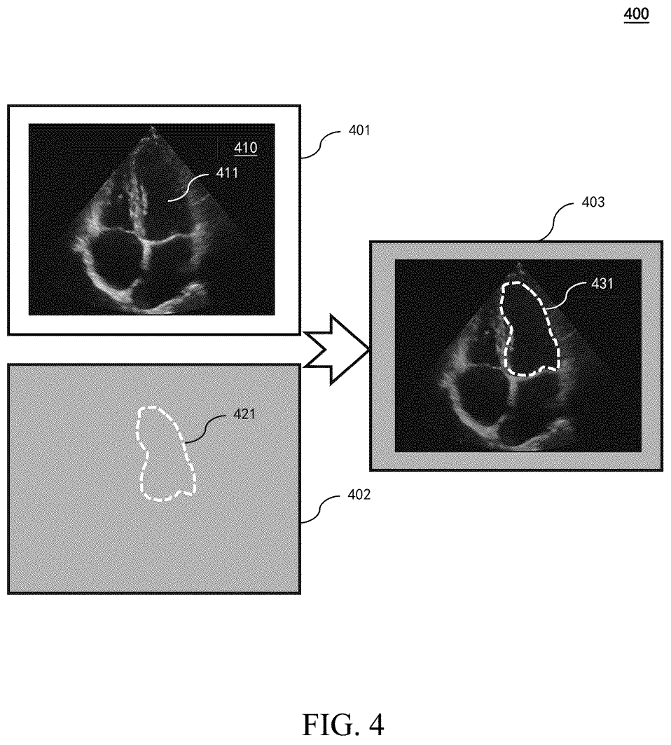

A more visual explanation, with reference to FIG. 4, is given below on the coordinated displaying of a medical image and a medical image processing result together by using a transparent display device and a display. FIG. 4 shows a schematic diagram 400 of performing auxiliary display by using a transparent display device in some embodiments of the present application. A display 401 and a transparent display device 402 are comprised. The display 401 may be the display 128 as shown in FIG. 1, and the transparent display device 402 may be the transparent display device 112 as shown in FIG. 1.

A medical image 410 is displayed on the display 401. The medical image 410 in the figure is explained by taking a two-dimensional cardiac ultrasound image as an example. However, as described above, the medical image 410 may be any other type of image that is obtained through real-time imaging by a medical imaging device. Further, the medical image 410 comprises a region of interest 411, which is explained by taking the left ventricle as an example. In the case where the medical imaging device does not have the function of automatic image processing, the identification of the region of interest 411 relies on manual work or on an external display device. In the embodiment of the present application, a transparent display device 402 is comprised, and a processing result 421 of the medical image 410 is displayed on the transparent display device 402. In the embodiment of FIG. 4, the processing result 421 is explained by taking the result of segmenting the region of interest 411 as an example, and the segmentation result is represented by a bounding box. Further, since the transparent display device 402 can allow visible light to pass therethrough, after the transparent display device 402 and the display 401 are arranged in a stacked manner, the display results of the two stacked display devices 403 can still be observed separately. Moreover, since the position of the region of interest 411 corresponds to the position of the segmentation result 421, a user will not perceive a significant visual deviation. The superimposed display result 431 appears more like image processing having been directly performed on the medical image displayed on the display 411, thereby improving the experience and work efficiency of the user.

It should be noted that FIG. 4 only shows a description of how two display apparatuses perform displaying in a superimposed manner. For the specific configuration of the display devices, reference can be made to the description of any of the foregoing embodiments of the present application, for example the description of the embodiments corresponding to FIG. 1 and FIG. 2, which will not be repeated here. In addition, while FIG. 4 shows identification and segmentation of the region of interest during image processing, any image processing and any method for displaying a processing result as described hereinabove apply likewise.

It can be learned from the description of the foregoing embodiments of the present application that it is very important to match the position of the processing result with the position of the medical image in a direction perpendicular to the transparent display device. Only in this way can the user observe the contents on both display devices as “the same image” when observing in the direction perpendicular to the transparent display device. The effect of matching may be achieved by various means. An exemplary explanation is given below.

In one example, a transparent display device having the same size and resolution as the display of a medical imaging device may be selected. Thus, after the two are aligned during an installation process, it can be ensured that the displaying positions of the two are consistent in the direction perpendicular to the screen.

A problem that might be associated with the above solution is that, in general, the displays of different medical imaging devices have different sizes and/or resolutions, and hence there is a need to configure different transparent display devices according to these different displays. Therefore, in other examples, conversion and adaption with respect to the size and resolution of the display of a medical imaging device can be performed so as to improve versatility.

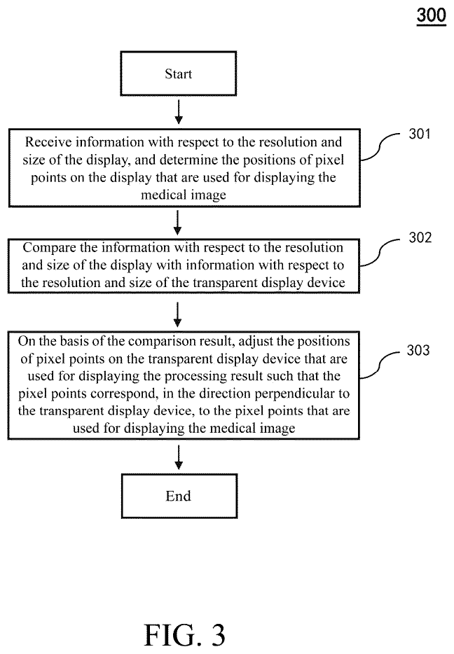

Reference is made to FIG. 3, which shows a method 300 for performing adaption between display apparatuses in some embodiments of the present application.

At step 301, information with respect to the resolution and size of the display is received, and the positions of pixel points on the display that are used for displaying the medical image are determined.

At step 302, the information with respect to the resolution and size of the display is compared with information with respect to the resolution and size of the transparent display device.

At step 303, on the basis of the comparison result, the positions of pixel points on the transparent display device that are used for displaying the processing result are adjusted such that the pixel points correspond, in the direction perpendicular to the transparent display device, to the pixel points that are used for displaying the medical image.

Such a configuration can improve the versatility of positional matching, such that the same transparent display apparatus can be used to adapt to the displays of different medical imaging devices. Specifically, in the above manner, actually, the transparent display apparatus and the display are compared in terms of the size and resolution so as to determine the deviation of the spatial positions of the pixel points on the two display apparatuses that are used for performing image displaying for the same medical image (of course, also including the processing result of a partial region of the medical image). Then computation is performed so as to adjust the displaying position on the transparent display apparatus such that it can correspond to the position on the display. Therefore, it is ensured that the position of the processing result and the position of the medical image to which the result refers are consistent in the direction perpendicular to the screen.

The above steps may be implemented using the processor of the medical image processing apparatus shown in FIG. 1. Specifically, the processor may acquire information of the display of the medical imaging device before or while acquiring the medical image of the medical imaging device. The manner of acquiring may likewise include different types. In an example, the processor may parse out information with respect to the resolution, size, etc., of the screen from the image data acquired from the medical imaging device. In other examples, the processor may also perform direct capture on the screen of the medical imaging device so as to obtain the image and the related information of the display at the same time.

It should be noted that the above embodiments and the technical effects thereof are merely exemplary descriptions. In light of the teaching in the present disclosure with respect to registration of two screens with each other in a front-back direction, any other prior art is also allowed to be used to perform registration, in terms of displaying, between the two screens.

Some embodiments of the present application further provide a non-transitory computer-readable medium, where the non-transitory computer-readable medium has a computer program stored thereon, the computer program has at least one code segment, and the at least one code segment is executable by a machine so as to enable the machine to perform the steps of the method described in any one of the above embodiments of the present application.

Disclosed in some embodiments of the present application is a medical image processing apparatus, comprising: a processor and a non-transitory memory. The non-transitory memory has instructions stored therein. The instructions, when executed, cause the processor to perform the method described in any embodiments of the present application.

It can be understood that, for the structural components of the medical image processing apparatus, reference can be made to any one or more of the foregoing embodiments of the present application.

For example, the apparatus may comprise a transparent display device that allows a display located therebehind to be observed through the transparent display device.

As another example, the apparatus may comprise a fixing apparatus, which is connected to the transparent display device and is capable of fixedly connecting the display to the transparent display device.

In an optional example, the fixing apparatus is further configured to be allowed to perform positional adjustment on the transparent display device in at least one of a horizontal direction and a vertical direction.

In addition, the medical image processing apparatus may further comprise a data receiving module, which is used to receive a medical image from the medical imaging device in real time for the processor to perform real-time processing. Optionally, the data receiving module further receives information with respect to the resolution and size of the display of the medical imaging device.

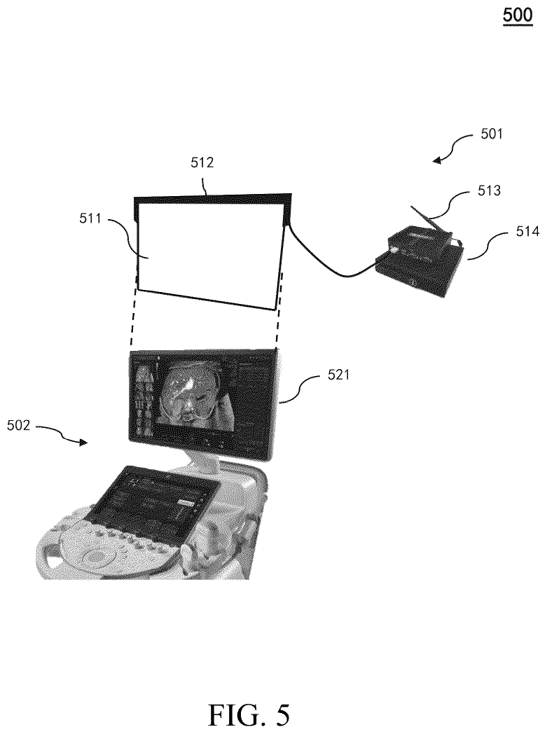

For case of understanding the medical image processing apparatus of the present application, a detailed description is provided with reference to FIG. 5. FIG. 5 shows a schematic diagram of a medical system 500 comprising a medical image processing apparatus. It can be understood that although the medical system 500 is depicted by means of graphical representation, any structure that is not described may be as described for any foregoing embodiments herein, for example, as described for the medical system 100 in FIG. 1.

As shown in FIG. 5, the medical system 500 comprises a medical image processing apparatus 501. Optionally, it may further comprise a medical imaging device 502. The medical image processing apparatus 501 comprises a transparent display device 511. The medical imaging device 502 (taking an ultrasound imaging device as an example) comprises a display 521. The transparent display device 511 is connected to a fixing apparatus 512. In the embodiment shown in FIG. 5, the fixing apparatus 512 is a clamp disposed on the transparent display device 511. The fixing apparatus 512 is configured to fix the transparent display device 511 onto the display 521 of the medical imaging device 502. For example, the transparent display device 511 may be hung over and fixed to the display 521 in an up-to-down direction. In an optional embodiment, the fixing apparatus 512 may allow performing positional adjustment on the transparent display device 511 in a horizontal or vertical direction (relative to the screen of the display 521). For example, the fixing apparatus 512 may comprise any position-adjusting device in the prior art, such as a guide rail, a height-adjusting device, etc. This facilitates alignment of the transparent display device 511 with respect to a predetermined position of the display 521. The predetermined position includes the upper center point of the screen, the center point of the screen, an edge of the screen, etc. The purpose of the alignment, as explained above, is to facilitate spatial registration of the displayed contents of the two devices.

Further, the medical imaging device 502 may further comprise other components, for example, a data receiving module 513. In the figure, the data receiving module 513 is implemented in a wireless manner, and in another example, it may be implemented by means of a cable. The data receiving module 513 is used to receive a medical image from the medical imaging device 502 in real time for the processor of the medical imaging device 502 to perform real-time processing. Optionally, the data receiving module 513 further receives information with respect to the resolution and size of the display 521 of the medical imaging device 502.

The medical imaging device 502 may further comprise a host 514. The host 514 houses core units therein, including the processor, whereby the medical image is processed in real time with an algorithm, and a processing result is generated to be displayed in real time by the transparent display device 511. In addition, the host 514 may further house therein other structures described in any of the foregoing embodiments of the present application, for example, the non-transitory memory 112 in FIG. 1. The solutions of any of the foregoing embodiments apply to FIG. 5, unless explicitly noted otherwise.

The present disclosure may be implemented by means of hardware, software, or a combination of hardware and software. The present disclosure may be implemented in at least one computer system in a centralized manner, or implemented in a distributed manner; and in the distributed manner, different elements are distributed on a plurality of interconnected computer systems. Any type of computer system or other apparatus suitable for implementing the methods described herein is considered to be appropriate.

Various embodiments may also be embedded in a computer program product, which includes all features capable of implementing the methods described herein, and the computer program product is capable of executing these methods when loaded into a computer system. The computer program in this context means any expression in any language, code, or symbol of an instruction set intended to enable a system having information processing capabilities to execute a specific function directly or after any or both of the following: a) conversion to another language, code, or symbol; and b) replication in different material forms.

The purpose of providing the above specific embodiments is to facilitate understanding of the content disclosed in the present invention more thoroughly and comprehensively, but the present invention is not limited to these specific embodiments. Those skilled in the art should understand that various modifications, equivalent replacements, and changes can also be made to the present invention and should be included in the scope of protection of the present invention as long as these changes do not depart from the spirit of the present invention.

1. A method for auxiliary display of a medical image, comprising:
acquiring a medical image from a medical imaging device in real time, the medical imaging device comprising a display for displaying the medical image in real time;
performing real-time processing on the medical image to generate a processing result; and
displaying the processing result on a transparent display device, and matching the position of the processing result with the position of the medical image in a direction perpendicular to the transparent display device.

2. The method according to claim 1, wherein:
the real-time processing comprises at least one of image recognition, image segmentation and image measurement; correspondingly, the processing result comprises at least one of a recognition result of a region of interest, a recognition result of a lesion, a classification of a lesion, a bounding box of a region of interest, a bounding box of a lesion, a coloration, and a measurement result.

3. The method according to claim 1, wherein:
the real-time processing comprises processing using a deep neural network.

4. The method according to claim 1, further comprising:
controlling the transparent display device not to display the medical image while the processing result is being displayed on the transparent display device.

5. The method according to claim 1, wherein the matching the position of the processing result with the position of the medical image in a direction perpendicular to the transparent display device comprises:
receiving information with respect to the resolution and size of the display, and determining the positions of pixel points on the display that are used for displaying the medical image;
comparing the information with respect to the resolution and size of the display with information with respect to the resolution and size of the transparent display device; and
on the basis of the comparison result, adjusting the positions of pixel points on the transparent display device that are used for displaying the processing result such that the pixel points correspond, in the direction perpendicular to the transparent display device, to the pixel points that are used for displaying the medical image.

6. A medical image processing apparatus, comprising:
a processor; and
a non-transitory memory, wherein the non-transitory memory has instructions stored therein, and the instructions, when executed, cause the processor to perform the method according to claim 1.

7. The medical image processing apparatus according to claim 6, further comprising:
a transparent display device, the transparent display device allowing a display located therebehind to be observed through the transparent display device.

8. The medical image processing apparatus according to claim 7, further comprising:
a fixing apparatus, the fixing apparatus being connected to the transparent display device and being capable of fixedly connecting the display to the transparent display device.

9. The medical image processing apparatus according to claim 8, wherein:
the fixing apparatus is further configured to be allowed to perform positional adjustment on the transparent display device in at least one of a horizontal direction and a vertical direction.

10. The medical image processing apparatus according to claim 6, further comprising:
a data receiving module, the data receiving module being used to receive a medical image from the medical imaging device in real time for the processor to perform real-time processing.

11. The medical image processing apparatus according to claim 10, wherein:
the data receiving module further receives information with respect to the resolution and size of the display of the medical imaging device.

12. A medical system, comprising the medical image processing apparatus according to claim 6.

13. The medical system according to claim 12, further comprising a medical imaging device, the medical imaging device comprising at least one of an ultrasound imaging device, an endoscope, an X-ray imaging device, and a magnetic resonance imaging device.
